(19) United States
(12) Patent Application Publication
(10) Pub. No.: US 2014/0347314 A1
(43) Pub. Date: Nov. 27, 2014

(54) METHOD OF DETECTING TOUCH FORCE AND DETECTOR

(71) Applicant: HIMAX TECHNOLOGIES LIMITED, Tainan City (TW)

(72) Inventors: Jui-Min Liu, Tainan City (TW); Chin-Lin Lee, Tainan City (TW); Li-Lin Liu, Tainan City (TW); Shen-Feng Tai, Tainan City (TW)

(73) Assignee: HIMAX TECHNOLOGIES LIMITED, Tainan City (TW)

(21) Appl. No.: 14/064,694

(22) Filed: Oct. 28, 2013

(30) Foreign Application Priority Data
May 24, 2013 (TW) 102118457

(51) Int. Cl. G06F 3/044

(52) U.S. Cl. CPC G06F 3/044
USPC 345/174

(57) ABSTRACT

A method of detecting a touch force capable of detecting a touch force applied to a touch panel by an object is provided. The method of detecting a touch force comprises following steps. The touch panel is provided. A relation between a sensing capacitance of the touch panel and the touch force is built. The object touches the touch panel, and a detecting sensing capacitance of the touch panel is obtained. A detecting result is obtained according the relation and the detecting sensing capacitance. Moreover, a detector is also provided.

### CROSS-REFERENCE TO RELATED APPLICATION

This application claims the priority benefit of Taiwan application serial no. 102118457, filed on May 24, 2013. The entirety of the above-mentioned patent application is hereby incorporated by reference herein and made a part of this specification.

### BACKGROUND OF THE INVENTION

1. Field of the Invention

The present invention is directed to a method of detecting force and a detector. More particularly, the present invention is directed to a method of detecting force by a touch panel and a detector including a touch panel.

2. Description of Related Art

In recent years, to achieve the goals of more convenient usage, more compact design and more humanized features, many information products have changed their input devices from traditional keyboard or mouse to touch panel. The touch panel can be assembled into various flat panel displays for the flat panel displays to obtain both functions of displaying images and inputting operation information.

At present, the touch panel can be generally classified into resistive touch panel and the capacitive touch panel. Especially, users can easily perform the touch operation by slightly touching the surface of the capacitive touch panel such that the users are favorable to the capacitive touch panel. However, conventional touch panels can only be applied for interfaces of inputting information, but can not be applied for other purposes.

### SUMMARY OF THE INVENTION

The present invention is directed to a method of detecting a touch force, which detects the touch force by properties of a touch panel.

The present invention is directed to a detector, which detects a touch force applied by an object on a touch panel.

The present invention provides a method of detecting a touch force, capable of detecting a touch force applied on a touch panel by an object. The method of detecting the touch force includes the following steps. The touch panel is provided. A relation between a sensing capacitance of the touch panel and the touch force is built. The touch panel is touched by the object, and a detecting sensing capacitance of the touch panel is obtained. A detecting result of the touch force according to the relation and the detecting sensing capacitance is obtained.

The present invention provides a detector, capable of detecting a touch force applied on the detector by an object. The detector includes a touch panel, a storage unit and a processing unit. The touch panel is capable of being touched by the object and generating a detecting sensing capacitance. A relation between a sensing capacitance of the touch panel and the touch force is built in the storage unit. The processing unit obtains a detecting result of the touch force according to the relation and the detecting sensing capacitance.

According to an embodiment of the present invention, the method of building the relation between the sensing capacitance of the touch panel and the touch force includes: building a first relation between the sensing capacitance of the touch panel in a self-capacitance mode and the touch force and building a second relation between the sensing capacitance of the touch panel in a mutual-capacitance mode and the touch force.

According to an embodiment of the present invention, the method of obtaining the detecting sensing capacitance of the touch panel includes: obtaining a self-capacitance sensing capacitance of the touch panel in the self-capacitance mode, and obtaining a mutual-capacitance sensing capacitance of the touch panel in the mutual-capacitance mode.

According to an embodiment of the present invention, the method of obtaining the detecting result of the touch force according to the relation and the sensing capacitance includes: obtaining the detecting result of the touch force according to the self-capacitance sensing capacitance, the mutual-capacitance sensing capacitance and at least one of the first relation and the second relation.

According to an embodiment of the present invention, the method of obtaining the detecting result of the touch force according to the self-capacitance sensing capacitance, the mutual-capacitance sensing capacitance and at least one of the first relation and the second relation includes: determining the touch panel is in either a bending state or a great-area touch state according to the self-capacitance sensing capacitance and the mutual-capacitance sensing capacitance, and if the touch panel in the bending state, obtaining the detecting result of the touch force according to the first relation and the self-capacitance sensing capacitance, the second relation and the mutual-capacitance sensing capacitance, or the first relation, the self-capacitance sensing capacitance, the second relation and the mutual-capacitance sensing capacitance.

According to an embodiment of the present invention, the method of obtaining the detecting result of the touch force according to the self-capacitance sensing capacitance, the mutual-capacitance sensing capacitance and at least one of the first relation and the second relation includes: determining the touch panel is in either a bending state or a great-area touch state according to the self-capacitance sensing capacitance and the mutual-capacitance sensing capacitance, and if the touch panel in the great-area touch state, obtaining the detecting result of the touch force according to the first relation and the self-capacitance sensing capacitance.

According to an embodiment of the present invention, the method of building the relation between the sensing capacitance of the touch panel and the touch force includes: building a first relation between the sensing capacitance of the touch panel in a self-capacitance mode and the touch force.

According to an embodiment of the present invention, the method of obtaining the detecting sensing capacitance of the touch panel includes: obtaining a self-capacitance sensing capacitance of the touch panel in the self-capacitance mode.

According to an embodiment of the present invention, the method of building the relation between the sensing capacitance of the touch panel and the touch force includes: building a second relation between the sensing capacitance of the touch panel in a mutual-capacitance mode and the touch force.

According to an embodiment of the present invention, the method of obtaining the detecting sensing capacitance of the touch panel includes: obtaining a mutual-capacitance sensing capacitance of the touch panel in the mutual-capacitance mode.

According to an embodiment of the present invention, the detector further includes a driving unit. The driving unit enables the touch panel to switch to the self-capacitance mode or the mutual-capacitance mode. The touch panel in the self-capacitance mode is capable of being touched by the object and generating a self-capacitance sensing capacitance. The touch panel in the mutual-capacitance mode is capable of being touched by the object and generating a mutual-capacitance sensing capacitance. According to an embodiment of the present invention, the first relation between the sensing capacitance of the touch panel in the self-capacitance mode and the touch force, and the second relation between the sensing capacitance of the touch panel in a mutual-capacitance mode and the touch force are built in the storage unit. The processing unit obtains the detecting result of the touch force according to the self-capacitance sensing capacitance, mutual-capacitance sensing capacitance, and at least one of the first relation and the second relation.

According to an embodiment of the present invention, the processing unit determines the touch panel is in either the bending state or the great-area touch state according to the self-capacitance sensing capacitance and the mutual-capacitance sensing capacitance, if the processing unit determines the touch panel is in the bending state, the processing unit obtains the detecting result of the touch force according to the first relation and the self-capacitance sensing capacitance, the second relation and the mutual-capacitance sensing capacitance, or the first relation, the self-capacitance sensing capacitance, the second relation and the mutual-capacitance sensing capacitance.

According to an embodiment of the present invention, the processing unit determines the touch panel is in either the bending state or the great-area touch state according to the self-capacitance sensing capacitance and the mutual-capacitance sensing capacitance, if the processing unit determines the touch panel is in the great-area touch state, the processing unit obtains the detecting result of the touch force according to the first relation and the self-capacitance sensing capacitance.

According to an embodiment of the present invention, the detector further includes a driving unit. The driving unit enables the touch panel to switch between the self-capacitance mode and the mutual-capacitance mode. The touch panel in the self-capacitance mode is capable of being touched by the object and generating a self-capacitance sensing capacitance. The first relation between the sensing capacitance of the touch panel in the self-capacitance mode and the touch force is built in the storage unit. The processing unit obtains the detecting result of the touch force according to the first relation and the self-capacitance sensing capacitance.

According to an embodiment of the present invention, the detector further includes a driving unit. The driving unit enables the touch panel to be operated in the mutual-capacitance mode. The touch panel in the mutual-capacitance mode is capable of being touched by the object and generating the mutual-capacitance sensing capacitance. The second relation between the sensing capacitance of the touch panel in the mutual-capacitance mode and the touch force is built in the storage unit. The processing unit obtains the detecting result of the touch force according to the second relation and the mutual-capacitance sensing capacitance.

Based on the above, an object touches a touch panel with different magnitude of force would cause different bending states of the touch panel, such that the sensing capacitance of the touch panel varies accordingly. The method of detecting the touch force and the detector according to the embodiments of the present invention detect the magnitude of the touch force by the above-mentioned properties.

In order to make the aforementioned and other features and advantages of the invention more comprehensible, embodiments accompanying figures are described in detail below.

### BRIEF DESCRIPTION OF THE DRAWINGS

FIG. 1 is a flowchart illustrating a method of detecting a touch force according to an embodiment of the invention.

FIG. 2 is a schematic view illustrating an object touching a touch panel according to an embodiment of the present invention.

FIG. 3 illustrates the original values representing the sensing capacitance of the touch panel when the object touches the touch panel with a force which the magnitude thereof is close to zero.

FIG. 4 illustrates the original values representing the sensing capacitance of the touch panel when the object touches the touch panel with a small force.

FIG. 5 illustrates the original values representing the sensing capacitance of the touch panel when the object touches the touch panel with a medium force.

FIG. 6 illustrates the original values representing the sensing capacitance of the touch panel when the object touches the touch panel with a great force.

FIG. 7 illustrates the relation between the sensing capacitance of the touch panel and the touch force according to an embodiment of the present invention.

FIG. 8 illustrates the original values representing the sensing capacitance of the touch panel.

FIG. 9 illustrates the relation between the sensing capacitance of the touch panel in the self-capacitance mode and the touch force according to an embodiment of the present invention.

FIG. 10 is a schematic view illustrating a detector according to an embodiment of the present invention.

FIG. 11 illustrates the relation between the sensing capacitance of the touch panel in the mutual-capacitance mode and the touch force according to an embodiment of the present invention.

FIG. 12 is a schematic view illustrating a detector according to an embodiment of the present invention.

### DESCRIPTION OF EMBODIMENTS

### First Embodiment

### Method of Detecting a Touch Force

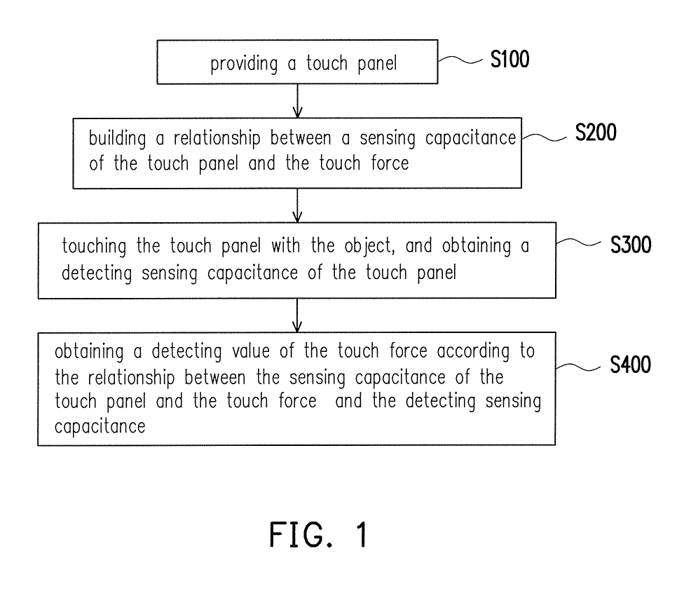

FIG. 1 is a flowchart illustrating a method of detecting a touch force according to an embodiment of the invention. Referring to FIG. 1, the method of detecting a touch force of the present embodiment includes the following steps. A touch panel is provided (Step 100). A relation between a sensing capacitance of the touch panel and the touch force is built (Step 200). The touch panel is touched by an object, and a detecting sensing capacitance of the touch panel is obtained (Step 300). A detecting result of the touch force is obtained according to the relation between the sensing capacitance of the touch panel and the touch force and the detecting sensing capacitance (Step 400). It should be noted that the sequence of the aforementioned steps S100, S200, S300, S400 is not restricted to the above, and the modifications of the sequence can be made. For example, Step S200 can be performed firstly, and then the step S100, step S300 and step S400 are then sequentially performed.

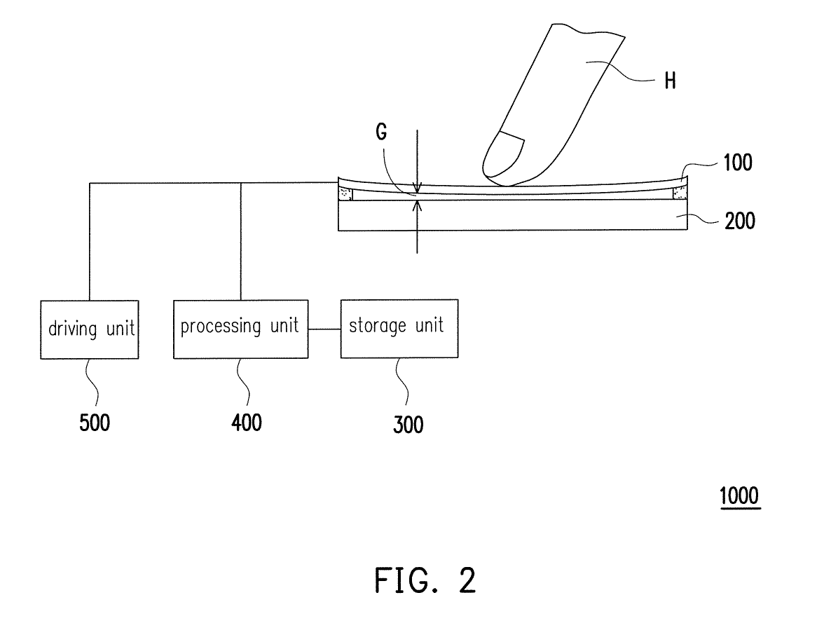

The method of detecting the touch force of the present embodiment is capable of detecting the touch force applied on the touch panel by the object. Detailed descriptions are provided below with figures. FIG. 2 is a schematic view of an object touching a touch panel according to an embodiment of the present invention. Referring to FIG. 2, firstly, a touch panel 100 is provided. In the present embodiment, the touch panel 100 may be disposed above the display panel 200. A gap G may exist between the touch panel 100 and the display panel 200. The touch panel 100 is, for example, a capacitive touch panel. The touch panel 100 may have a plurality of sensing strings. The sensing strings can be divided into a plurality of first sensing strings and a plurality of second sensing strings intersected with the first sensing strings.

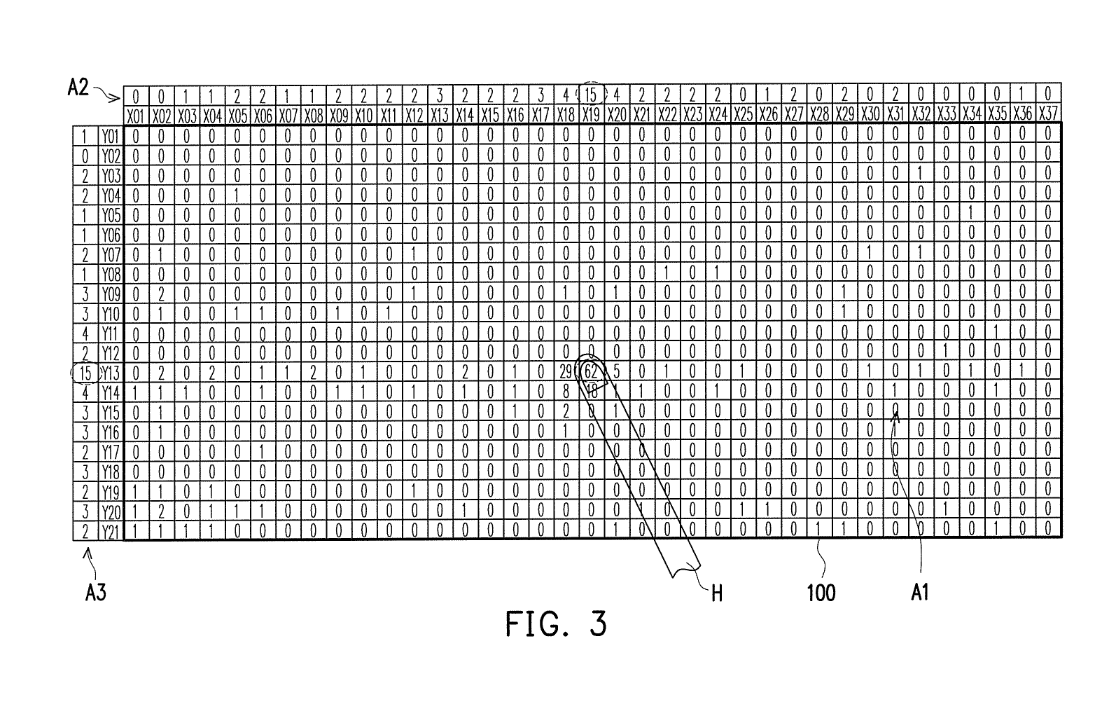

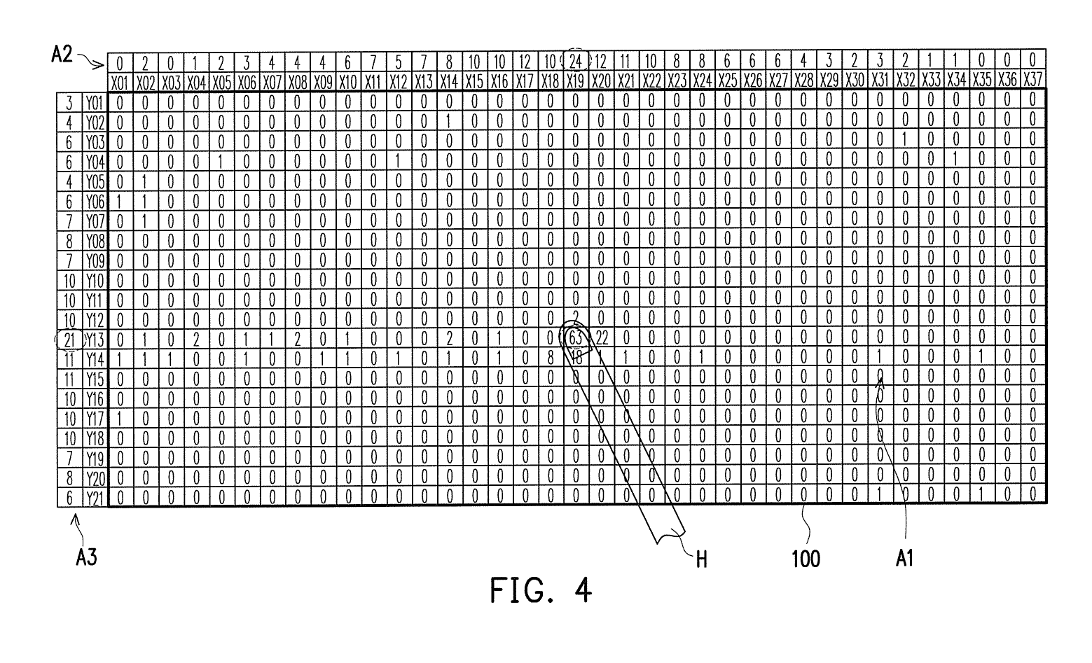

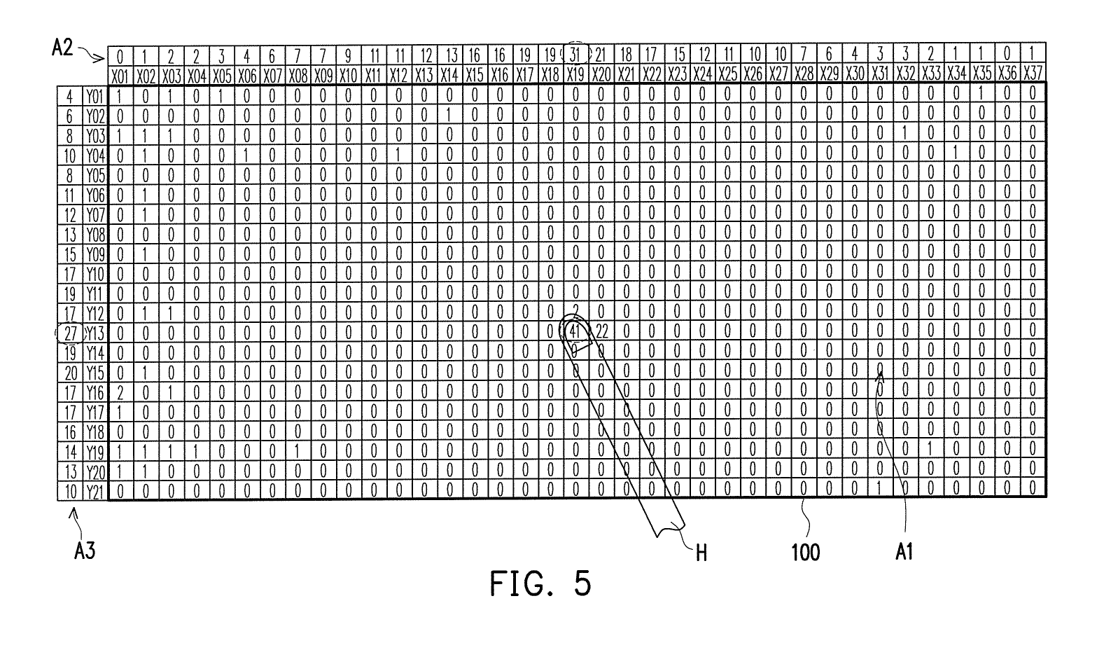

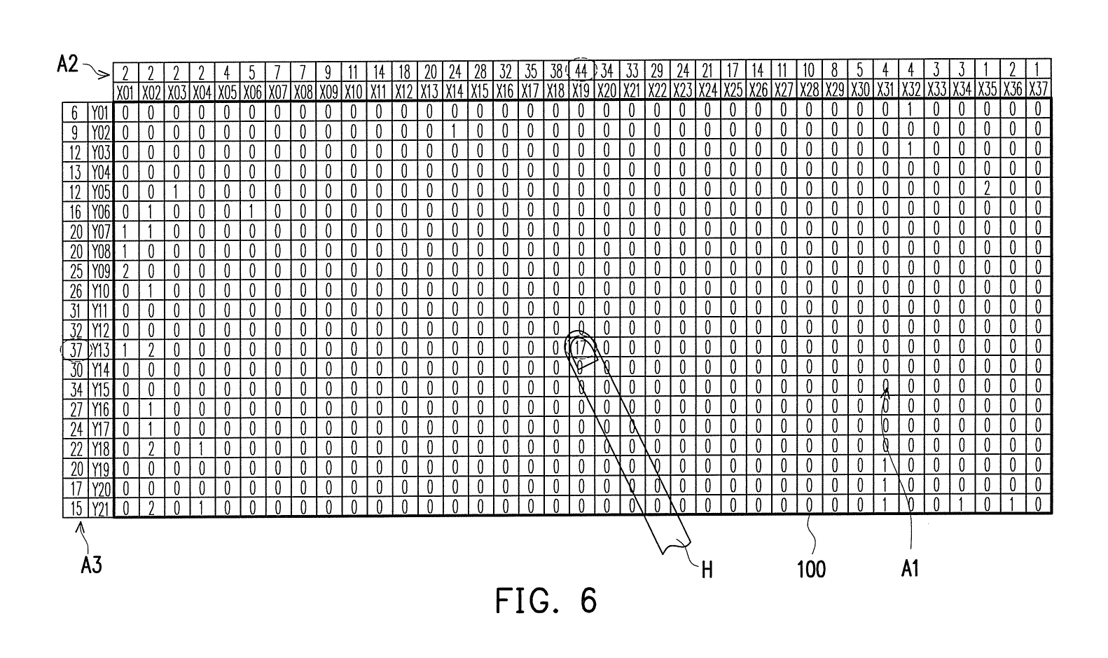

FIG. 3 illustrates the original values representing the sensing capacitance of the touch panel when the object touches the touch panel with a force which the magnitude thereof is close to zero. FIG. 4 illustrates the original values representing the sensing capacitance of the touch panel when the object touches the touch panel with a small force. FIG. 5 illustrates the original values representing the sensing capacitance of the touch panel when the object touches the touch panel with a medium force. FIG. 6 illustrates the original values representing the sensing capacitance of the touch panel when the object touches the touch panel with a great force. In particular, the original values illustrated in the middle areas A1 in FIG. 3, FIG. 4, FIG. 5 and FIG. 6 represent the mutual-capacitance sensing capacitance of the touch panel at the marked location of the original values. A plurality of original data illustrated in the areas A2 and A3 represent the self-capacitance sensing capacitance of the touch panel at the marked location of the original values. Referring to FIG. 3, for example, the original value 62 represents the mutual-capacitance sensing capacitance at the intersection of the 19^{th} first sensing string X19 and the 13^{th} second sensing string Y13. The original value 15 located in area A2 represents the self-capacitance sensing capacitance of the 19^{th} first sensing string X19. The original value 15 located in area A3 represents the self-capacitance sensing capacitance of the 13^{th} second sensing string Y13.

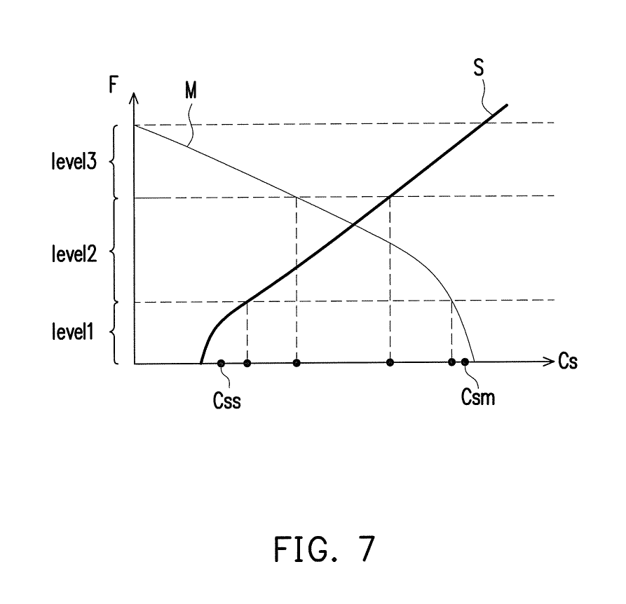

Referring to FIG. 4, FIG. 5 and FIG. 6 sequentially, when the touch force applied by the object H on the touch panel 100 increases, the original value of the touch panel 100 representing the mutual-capacitance sensing capacitance decreases, for example, decreasing from 63 to 41 and then further decreasing from 41 to 17. On the other hand, when the touch force applied by the object H on the touch panel 100 increases, the original value of the touch panel 100 representing the self-capacitance sensing capacitance increases, for example, increasing from 24 to 31 and then further increasing from 31 to 44. Based on the above-mentioned properties, a relation between a sensing capacitance of the touch panel 100 and the touch force can be built. FIG. 7 illustrates the relation between the sensing capacitance of the touch panel and the touch force according to an embodiment of the present invention. Referring to FIG. 7, to be more specific, in the present embodiment, a first relation S between the sensing capacitance Cs of the touch panel 100 in the self-capacitance mode and the touch force F is built, and a second relation M between the sensing capacitance Cs of the touch panel 100 in a mutual-capacitance mode and the touch force is also built.

Referring to FIG. 1, next, the touch panel 100 is touched by the object H, and a detecting sensing capacitance of the touch panel 100 is obtained. The object is, for example, a finger. However, the present invention is not limited thereto. In other embodiments, the object H may be other conductive objects. More specifically, in the present embodiment, a self-capacitance sensing capacitance of the touch panel 100 in the self-capacitance mode and a mutual-capacitance sensing capacitance of the touch panel 100 in the mutual-capacitance mode are obtained. Then, a detecting result of the touch force is obtained according to the self-capacitance sensing capacitance, mutual-capacitance sensing capacitance, and at least one of the first relation and the second relation. Referring to FIG. 7, for example, the obtained self-capacitance sensing capacitance Css and mutual-capacitance sensing capacitance Csm are compared respectively with the first relation S and the second relation M in FIG. 7, wherein the self-capacitance sensing capacitance Css and the mutual-capacitance sensing capacitance Csm respectively correspond to level 1 of the force level, so as to obtain the touch force applied on the touch panel by the object H falling in the level 1 region of the force level.

To be more specific, in the present embodiment, the method of obtaining the detecting result of the touch force according to according to the self-capacitance sensing capacitance, mutual-capacitance sensing capacitance, and at least one of the first relation and the second relation includes the following steps. The touch panel 100 in either a bending state or a great-area touch state is determined according to the self-capacitance sensing capacitance and the mutual-capacitance sensing capacitance. Referring to FIG. 5, for example, when the original value representing the self-capacitance sensing capacitance decreases gradually with an increase in a distance away from the touch location of the object H, for example, decreasing from 31 to 21 and then decreasing from 21 to 18, the touch panel can be determined to be in the bending state. At the time, similar to the above-mentioned description, the detecting result of the touch force is obtained according to the first relation S and the self-capacitance sensing capacitance Css, the second relation M and the mutual-capacitance sensing capacitance Csm, or the first relation S, the self-capacitance sensing capacitance Css, the second relation M and the mutual-capacitance sensing capacitance Csm.

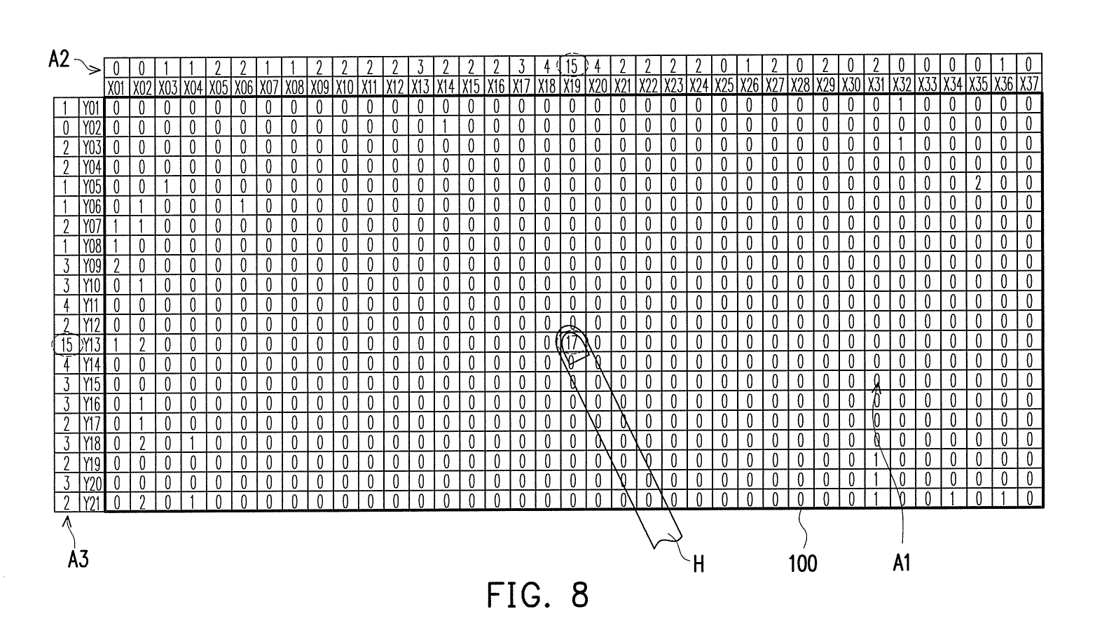

On the other hand, if the touch panel is determined to be in the great-area touch state according to the self-capacitance sensing capacitance and the mutual-capacitance sensing capacitance, the detecting result of the touch force can be obtained according to the first relation and the self-capacitance sensing capacitance instead of according to the second relation and the mutual-capacitance sensing capacitance, such that the detecting result of the touch force with high reliability is obtained. FIG. 8 illustrates the original values representing the sensing capacitance of the touch panel. Referring to FIG. 8, for example, when the original value representing the self-capacitance sensing capacitance decreases rapidly with an increase in a distance away from the touch location of the object H, for example, decreasing rapidly from 15 to 4 and then decreasing from 4 to 2, and the original value, for example, 17, representing the mutual-capacitance sensing capacitance corresponding to the touch location is smaller, the touch panel is determined to be in the great-area touch state. Meanwhile, the detecting result of the touch force is obtained according to the first relation and the self-capacitance sensing capacitance, such that the detecting result of the touch force with high reliability is obtained.

### Detector

Referring to FIG. 2, the detector 1000 of the present embodiment is capable of detecting a touch force applied on the detector 1000 by an object H. The detector 1000 includes a touch panel 100, a storage unit 300 and a processing unit 400. The touch panel 100 is capable of being touched by the object H and generating a detecting sensing capacitance. The relation between a sensing capacitance of the touch panel 100 and the touch force is built in the storage unit 300. The processing unit obtains a detecting result of the touch force according to the relation and the detecting sensing capacitance.

The detector 1000 of the present embodiment further includes a driving unit 500. The driving unit 500 enables the touch panel 100 to switch to the self-capacitance mode or the mutual-capacitance mode. The touch panel in the self-capacitance mode is capable of being touched by the object H and generating a self-capacitance sensing capacitance. The touch panel 100 in the mutual-capacitance mode is capable of being touched by the object H and generating the mutual-capacitance sensing capacitance. A first relation between the sensing capacitance of the touch panel in the self-capacitance mode and the touch force, and a second relation between the sensing capacitance of the touch panel in a mutual-capacitance mode and the touch force are built in the storage unit 300. The processing unit 400 obtains the detecting result of the touch force according to the self-capacitance sensing capacitance, mutual-capacitance sensing capacitance, and at least one of the first relation and the second relation.

To be more specific, the processing unit 400 of the present embodiment determines the touch panel is in either a bending state or a great-area touch state according to the self-capacitance sensing capacitance and the mutual-capacitance sensing capacitance. If the processing unit 400 determines that the touch panel is in the bending state, the processing unit 400 obtains the detecting result of the touch force according to the first relation and the self-capacitance sensing capacitance, the second relation and the mutual-capacitance sensing capacitance, or the first relation, the self-capacitance sensing capacitance, the second relation and the mutual-capacitance sensing capacitance. If the processing unit 400 determines that the touch panel 100 is in the great-area touch state, the processing unit 400 obtains the detecting result of the touch force according to the first relation and the self-capacitance sensing capacitance instead of according to the second relation and the mutual-capacitance sensing capacitance, such that the reliability of the detector 1000 detecting the touch force is enhanced.

### Second Embodiment

### Method of Detecting a Touch Force

The method of detecting the touch force of the present embodiment is similar to the first embodiment. Please refer to the first embodiment for the same parts. The method of detecting a touch force of the present embodiment includes the following steps. A touch panel is provided. A first relation between the sensing capacitance of the touch panel in the self-capacitance mode and the touch force is built. The touch panel is touched by the object, and a self-capacitance sensing capacitance of the touch panel in the self-capacitance mode is obtained. The detecting result of the touch force is obtained according to the first relation and the self-capacitance sensing capacitance.

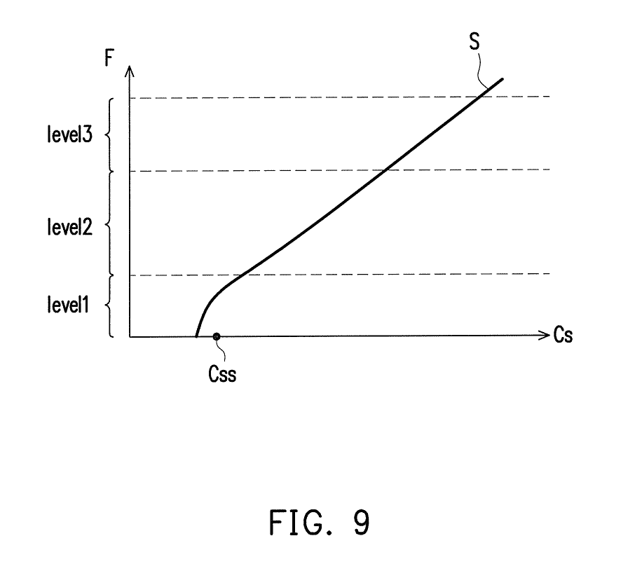

FIG. 9 illustrates the relation between the sensing capacitance of the touch panel in the self-capacitance mode and the touch force according to an embodiment of the present invention. Referring to FIG. 9, for example, the obtained self-capacitance sensing capacitance Css is compared with the built first relation S, and the self-capacitance sensing capacitance Css corresponds to level 1 of the force level, such that the touch force applied on the touch panel by the object H falling in the level 1 region of the force level is obtained.

### Detector

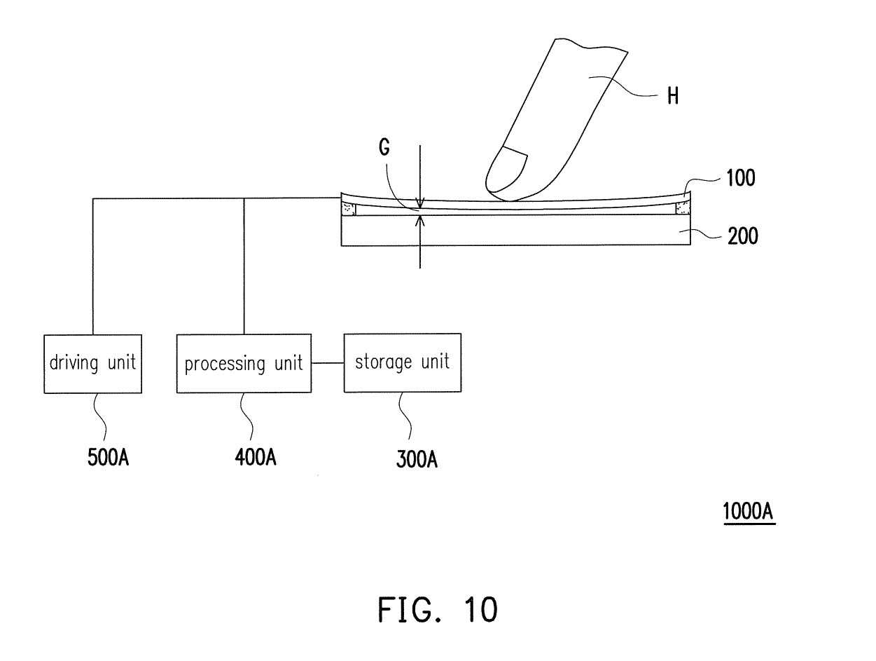

FIG. 10 is a schematic view illustrating a detector according to an embodiment of the present invention. The detector 1000A of the present embodiment is similar to the first embodiment. Therefore, the same components are represented by the same reference numbers. Referring to FIG. 10, the detector 1000A of the present embodiment is capable of detecting a touch force applied on the detector 1000A by an object H. The detector 1000A includes a touch panel 100, a storage unit 300A, a processing unit 400A and a driving unit 500A. The driving unit 500A enables the touch panel 100 to be operated in a self-capacitance mode. The touch panel 100 in the self-capacitance mode is capable of being touched by the object H and generating a self-capacitance sensing capacitance. A first relation between the sensing capacitance of the touch panel in the self-capacitance mode and the touch force is built in the storage unit 300A. The processing unit 400A obtains the detecting result of the touch force according to the first relation and the self-capacitance sensing capacitance.

### The Third Embodiment

### Method of Detecting a Touch Force

The method of detecting the touch force of the present embodiment is similar to the first embodiment. Please refer to the first embodiment for the same parts. The method of detecting a touch force of the present embodiment includes the following steps. A touch panel is provided. A second relation between the sensing capacitance of the touch panel in a mutual-capacitance mode and the touch force is built. The touch panel is touched by the object, and a mutual-capacitance sensing capacitance of the touch panel in the mutual-capacitance mode is obtained. The detecting result of the touch force is obtained according to the second relation and the mutual-capacitance sensing capacitance.

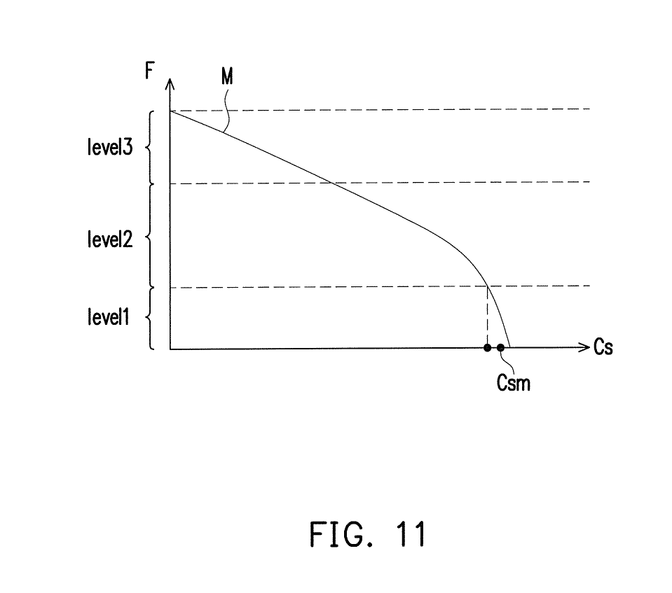

FIG. 11 illustrates the relation between the sensing capacitance of the touch panel in the mutual-capacitance mode and the touch force according to an embodiment of the present invention. Referring to FIG. 11, for example, the obtained mutual-capacitance sensing capacitance Csm is compared with the built second relation M. The mutual-capacitance sensing capacitance Csm corresponds to level 1 of the force level, such that the touch force applied on the touch panel 100 by the object H falling in the level 1 region of the force level is obtained.

### Detector

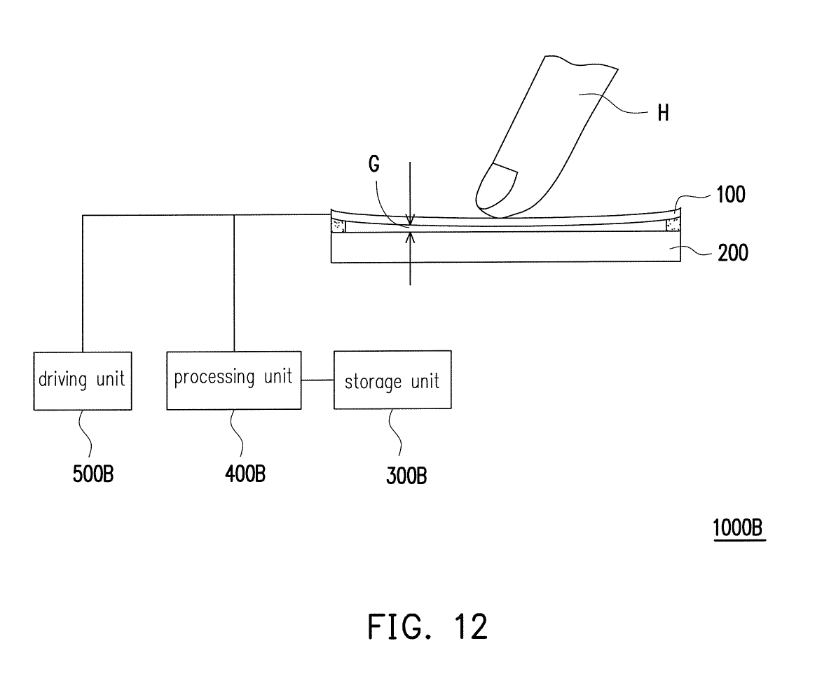

FIG. 12 is a schematic view illustrating a detector according to an embodiment of the present invention. The detector 1000B of the present embodiment is similar to the first embodiment. Therefore, the same components are represented by the same reference numbers. Referring to FIG. 12, the detector 1000B of the present embodiment is capable of detecting a touch force applied on the detector 1000B by an object H. The detector 1000B includes a touch panel 100, a storage unit 300B, a processing unit 400B and a driving unit 500B. The driving unit 500B enables the touch panel 100 to be operated in a mutual-capacitance mode. The touch panel 100 in the mutual-capacitance mode is capable of being touched by the object H and generating the mutual-capacitance sensing capacitance. A second relation between the sensing capacitance of the touch panel in the mutual-capacitance mode and the touch force is built in the storage unit 300B. The processing unit 400B obtains the detecting result of the touch force according to the second relation and the mutual-capacitance sensing capacitance.

Based on the above, an object touches a touch panel with different magnitude of force would cause different bending states of the touch panel, and the sensing capacitance of the touch panel varies accordingly. The method of detecting the touch force and the detector according to the embodiments of the present invention detect the magnitude of the touch force by the above-mentioned properties.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of detecting a touch force, capable of detecting a touch force applied to a touch panel by an object, the method of detecting the touch force comprising:
providing the touch panel;
building a relation between a sensing capacitance of the touch panel and the touch force;
touching the touch panel with the object, and obtaining a detecting sensing capacitance of the touch panel; and
obtaining a detecting result of the touch force according to the relation and the detecting sensing capacitance.

2. The method of detecting the touch force as claimed in claim 1, wherein the method of building the relation between the sensing capacitance of the touch panel and the touch force comprises: building a first relation between the sensing capacitance of the touch panel in a self-capacitance mode and the touch force; and building a second relation between the sensing capacitance of the touch panel in a mutual-capacitance mode and the touch force, the method of obtaining the detecting sensing capacitance of the touch panel comprising: obtaining a self-capacitance sensing capacitance of the touch panel in the self-capacitance mode; and obtaining a mutual-capacitance sensing capacitance of the touch panel in the mutual-capacitance mode, the method of obtaining the detecting result of the touch force according to the relation and the detecting capacitance comprising: obtaining the detecting result of the touch force according to the self-capacitance sensing capacitance, the mutual-capacitance sensing capacitance and at least one of the first relation and the second relation.

3. The method of detecting the touch force as claimed in claim 2, wherein obtaining the detecting result of the touch force according to the self-capacitance sensing capacitance, the mutual-capacitance sensing capacitance and at least one of the first relation and the second relation comprises:
determining the touch panel is in either a bending state or a great-area touch state according to the self-capacitance sensing capacitance and the mutual-capacitance sensing capacitance;
if the touch panel is in the bending state, obtaining the detecting result of the touch force according to the first relation and the self-capacitance sensing capacitance, the second relation and the mutual-capacitance sensing capacitance, or the first relation, the self-capacitance sensing capacitance, the second relation and the mutual-capacitance sensing capacitance.

4. The method of detecting the touch force as claimed in claim 2, wherein obtaining the detecting result of the touch force according to the self-capacitance sensing capacitance, the mutual-capacitance sensing capacitance and at least one of the first relation and the second relation comprises:
determining the touch panel is in either a bending state or a great-area touch state according to the self-capacitance sensing capacitance and the mutual-capacitance sensing capacitance;
if the touch panel is in the great-area touch state, obtaining the detecting result of the touch force according to the first relation and the self-capacitance sensing capacitance.

5. The method of detecting the touch force as claimed in claim 1, wherein the method of building the relation between the sensing capacitance of the touch panel and the touch force comprises: building a first relation between the sensing capacitance of the touch panel in a self-capacitance mode and the touch force; the method of obtaining the detecting sensing capacitance of the touch panel comprises: obtaining a self-capacitance sensing capacitance of the touch panel in the self-capacitance mode.

6. The method of detecting the touch force as claimed in claim 1, wherein the method of building the relation between the sensing capacitance of the touch panel and the touch force comprises: building a second relation between the sensing capacitance of the touch panel in a mutual-capacitance mode and the touch force; the method of obtaining the detecting sensing capacitance of the touch panel comprises: obtaining a mutual-capacitance sensing capacitance of the touch panel in the mutual-capacitance mode.

7. A detector, capable of detecting a touch force applied to the detector by an object, the detector comprising:
a touch panel, capable of being touched by the object and generating a detecting sensing capacitance;
a storage unit, a relation between a sensing capacitance of the touch panel and the touch force is built therein; and
a processing unit, obtaining a detecting result of the touch force according to the relation and the detecting sensing capacitance.

8. The detector as claimed in claim 7, further comprising:
a driving unit, enabling the touch panel to switch to a self-capacitance mode or a mutual-capacitance mode, the touch panel in the self-capacitance mode capable of being touched by the object and generating a self-capacitance sensing capacitance, the touch panel in the mutual-capacitance mode capable of being touched by the object and generating a mutual-capacitance sensing capacitance, a first relation between the sensing capacitance of the touch panel in the self-capacitance mode and the touch force and a second relation between the sensing capacitance of the touch panel in the mutual-capacitance mode and the touch force are built in the storage unit, the processing unit obtaining the detecting result of the touch force according to the self-capacitance sensing capacitance, the mutual-capacitance sensing capacitance and at least one of the first relation and the second relation.

9. The detector as claimed in claim 8, wherein the processing unit determines the touch panel is in either a bending state or a great-area touch state according to the self-capacitance sensing capacitance and the mutual-capacitance sensing capacitance, if the processing unit determines the touch panel in the bending state, the processing unit obtains the detecting result of the touch force according to the first relation and the self-capacitance sensing capacitance, the second relation and the mutual-capacitance sensing capacitance, or the first relation, the self-capacitance sensing capacitance, the second relation and the mutual-capacitance sensing capacitance.

10. The detector as claimed in claim 8, wherein the processing unit determines the touch panel in either a bending state or a great-area touch state according to the self-capacitance sensing capacitance and the mutual-capacitance sensing capacitance, if the processing unit determines the touch panel in the great-area touch state, the processing unit obtains the detecting result of the touch force according to the first relation and the self-capacitance sensing capacitance.

11. The detector as claimed in claim 7, further comprising:
a driving unit, enabling the touch panel to be operated in a self-capacitance mode, the touch panel in the self-capacitance mode capable of being touched by the object and generating a self-capacitance sensing capacitance, a first relation between the sensing capacitance of the touch panel in the self-capacitance mode and the touch force built in the storage unit, the processing unit obtaining the detecting result of the touch force according to the first relation and the self-capacitance sensing capacitance.

12. The detector as claimed in claim 7, further comprising:
a driving unit, enabling the touch panel to be operated in a mutual-capacitance mode, the touch panel in the mutual-capacitance mode capable of being touched by the object and generating a mutual-capacitance sensing capacitance, a second relation between the sensing capacitance of the touch panel in the mutual-capacitance mode and the touch force built in the storage unit, the processing unit obtaining the detecting result of the touch force according to the second relation and the mutual-capacitance sensing capacitance.
